(19) United States
(12) Patent Application Publication
(10) Pub. No.: US 2023/0411705 A1
(43) Pub. Date: Dec. 21, 2023

(54) LITHIUM IRON PHOSPHATE BATTERY MODULE

(71) Applicant: TROJAN BATTERY COMPANY, LLC, Santa Fe Springs, CA (US)

(72) Inventors: Gary KUKEL, Santa Fe Springs, CA (US); Christopher BENDER, Santa Fe Springs, CA (US); Tom SPARANGO, Santa Fe Springs, CA (US)

(73) Assignee: TROJAN BATTERY COMPANY, LLC, Santa Fe Springs, CA (US)

(21) Appl. No.: 17/807,964

(22) Filed: Jun. 21, 2022

(51) Int. Cl. H01M 10/42; H01M 50/216; H01M 4/66; H01M 4/58; H01M 10/48; H01M 50/536

(52) U.S. Cl. CPC H01M 10/425; H01M 50/216; H01M 4/661; H01M 4/5825; H01M 10/482; H01M 10/486; H01M 50/536; H01M 2010/4271

(57) ABSTRACT

Disclosed is a lithium iron phosphate module having seventy-two (72) 26650 lithium iron phosphate cylindrical cells arranged in an 8S9P architecture, with the “S” being the number of supercells connected in series and the “P” being the number of cells connected in parallel. A five-layer clad material forms at least two current collector plates that are interconnected to the lithium iron phosphate cylindrical cells by a resistive welding process. The current collector plates each have a tab custom stamped on the five-layer clad material that is connected to a battery management system by running a voltage sense wire with a quick disconnect tab on the end from the battery management system to the custom stamped tab to monitor and balance the 24V output and 34Ah current of the cells in the module. At least two cell holders enclose the lithium iron phosphate cylindrical cells and the current collector plates.

### FIELD OF THE INVENTION

The present disclosure relates to the chemical and electrical arts. More specifically, the present disclosure relates to lithium iron phosphate (LiFePO₄) modules that are configurable to make several different series and parallel configurations to serve different markets and applications.

### BACKGROUND OF THE INVENTION

A lead-acid battery includes a housing containing a positive electrode plate and a negative electrode plate. The electrode plates are typically formed of an electrode grid coated with an active material. While primarily constructed of lead, the electrode grids are often alloyed with antimony, calcium, or tin to improve their mechanical characteristics. Antimony is generally a preferred alloying material. It is a drawback of such batteries that antimony may leach or migrate out of the positive electrode. Antimony deposition/poisoning of the negative plate leads to increased hydrogen evolution, electrolyte expenditure and loss of capacity and cycle life. Once the antimony deposits on the surface of the negative electrode, it will change potential of the negative electrode and cause the battery to be easily overcharged during use. This will undesirably shorten the battery life.

One approach to overcoming this problem of lead-acid batteries is to use prismatic cells. Prismatic cells are light, thin, and effectively use up space. Prismatic cells do not contain any acid or lead, which eliminates the problem of gasses being emitted while charging.

Unfortunately, there are numerous drawbacks to the use of prismatic cells in addition to its expense. These drawbacks include short lifespans due to ineffective thermal management systems, high sensitivity to deformation when exposed to high-pressure, and a fixed cell arrangement with no flexibility.

Consequently, there remains a long felt need to produce a 48V lithium battery in the GC2 size. GC2 batteries can fit aftermarket golf cart applications. Typical products in this size are either prismatic cells, i.e., which does not allow for flexible configurations, or hold a lesser quantity of cells, i.e., around 100 cells. Additionally, the connection method used for voltage monitoring and cell balancing is usually conducted with a ring lug with mechanical fasteners or a soldered wire. Thus, there remains a further long felt need for a smart battery that includes lithium iron phosphate (LiFePO₄) modules with cylindrical cells and a current collector plate design with quick disconnect tab connections as voltage sensors that possess desirable physical and mechanical properties such as resistance to vibration and shock, faster charging, longer range, easy assembly, and a heavy-duty off-road ready automotive design.

### SUMMARY OF THE DISCLOSURE

Now in accordance with the present disclosure, there has been discovered a lithium iron phosphate module that overcomes these related disadvantages. The lithium iron phosphate module which in one embodiment is part of a lithium battery pack, comprises a housing containing a positive and a negative single stud terminal post. A cover with lifting brackets is placed on top of the housing, which can be removed to insert the lithium iron phosphate module and a battery management system.

In one embodiment, a first lithium iron phosphate module contains a first set of lithium iron phosphate cylindrical cells and at least two current collector plates that are interconnected by a resistive welding process and enclosed in at least two cell holders. In some embodiments, a front side of the first lithium iron phosphate module contains five current collector plates interconnected to the cells and a rear side of the first lithium iron phosphate module contains four current collector plates interconnected to the cells. In another embodiment, the first lithium iron phosphate module is connected to a second lithium iron phosphate module in series. The second lithium iron phosphate module is identical to the first lithium iron phosphate module.

In one aspect of the embodiment, the first and the second lithium iron phosphate module each contain seventy-two (72) lithium iron phosphate cylindrical cells configured in an 8S9P configuration with a 24V output and about a 34 Ah current. In another embodiment, when the first lithium iron phosphate module, known as the low module, is connected to the second lithium iron phosphate module, known as the high module, in series, the one hundred and forty-four (144) lithium iron phosphate cylindrical cells are arranged in an 16S9P configuration with a 48V output and about a 34 Ah current and are able to be packed into a GC2 battery group size.

Each lithium iron phosphate cylindrical cell is a 26650 lithium iron phosphate cylindrical cell, meaning the lithium iron phosphate cylindrical cell has a diameter of about twenty-six (26) millimeters and a length of about sixty-five (65) millimeters. In some embodiments, the seventy-two (72) lithium iron phosphate cylindrical cells are arranged in an alternative series and parallel configuration. When the lithium iron phosphate cylindrical cells are arranged in an alternative series and parallel configuration, a different voltage output and current flow is produced.

In another aspect of the embodiment, the current collector plates are comprised of a five-layer clad material that includes two layers of corrosion resistant nickel on the surface, two layers of stainless steel between the two layers of nickel for welding, and a copper layer at the core for current carrying.

In yet another aspect of the embodiment, the lithium iron phosphate module further contains tabs that are custom stamped in the current collector plates. Each current collector plate includes one custom stamped tab. Through the custom stamped tabs, the battery management system monitors and balances the voltage of the lithium iron phosphate cylindrical cells. This is done by connecting the custom stamped tabs to the battery management system by running voltage sense wires with quick disconnect tabs on the end from the battery management system to the custom stamped tab. In some embodiments, the voltage sense wires are taped onto the current collector plates by a polyimide material.

In still another aspect, the lithium iron phosphate modules further include temperature sensors. The temperature sensors are connected to the battery management system and mounted on the lithium iron phosphate module at predetermined locations. If the temperature sensor reads a temperature outside of the recommended operating temperature range, the battery management system shuts down. The recommended operating temperatures are as follows: 0° C. to 45° C. (32° F. to 113° F.) during charge; −20° C. to 60° C. (−4° F. to 140° F.) during discharge; and −40° C. to 60° C. (−40° F. to 140° F.) in storage. In some embodiments where the low module is connected to the high module in series, the low module contains three temperature sensors and the high module contains one temperature sensor.

According to all of the foregoing, a few of the main advantages of this invention is providing a heavy-duty off-road ready automotive design that has faster charging and a longer range. Compared to a lead acid battery, this invention is a flexible, smart battery that is lighter in weight, easy to assemble, and does not emit gasses while charging, thereby achieving an improvement in the safety of a battery.

The above and other features, elements, characteristics, steps, and advantages of the present invention will become more apparent from the following detailed description of preferred embodiments of the present invention with reference to the attached drawings.

### BRIEF DESCRIPTION OF THE DRAWINGS

The accompanying drawings, together with the specification, illustrate exemplary embodiments, and, together with the description, serve to explain the principles of these embodiments.

FIG. 1 is a perspective view illustrating a lithium battery pack in accordance with one aspect of the invention.

FIG. 2 is a perspective view of a low module and a high module connected in series.

FIG. 3 is a front view illustrating a low module in accordance with one aspect of the invention.

FIG. 4 is a rear view of FIG. 3 illustrating a low module in accordance with one aspect of the invention.

FIG. 5 is a front view illustrating a high module in accordance with one aspect of the invention.

FIG. 6 is a rear view of FIG. 5 illustrating a low module in accordance with one aspect of the invention.

FIG. 7a is a perspective view illustrating a custom stamped tab in accordance with one aspect of the invention.

FIG. 7b is a perspective view illustrating a quick disconnect tab in accordance with one aspect of the invention.

FIG. 8 is a front view illustrating a clad material in accordance with one aspect of the invention.

### DETAILED DESCRIPTION

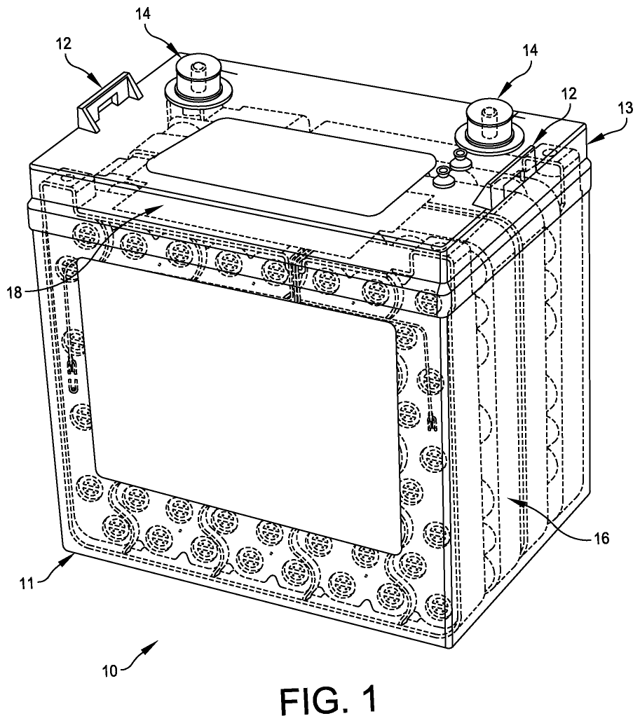

In FIG. 1 there is represented a lithium battery pack. As seen clearly in FIG. 1, this lithium battery pack 10 includes a housing 11 having positive and negative single stud terminal posts 14 extending through the top of the housing 11 to allow for electrical clamps to connect to the battery for operation. Although the terminal posts 14 are shown as extending through the top of the housing 11, the terminal posts 14 may alternatively be located in another position, according to embodiments of the present invention. For example, the terminal posts 14 may extend through the side of the housing 11. The housing 11 includes a cover 13 with lifting brackets 12 that allow the cover to be removed to insert at least one module 16 and a battery management system 18. The battery management system 18 is connected to the module 16 with voltage sense wires (not pictured here) to program and control the battery.

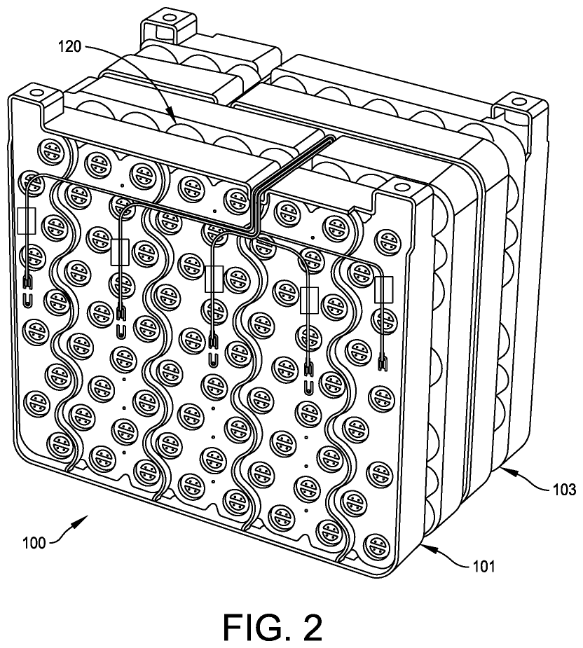

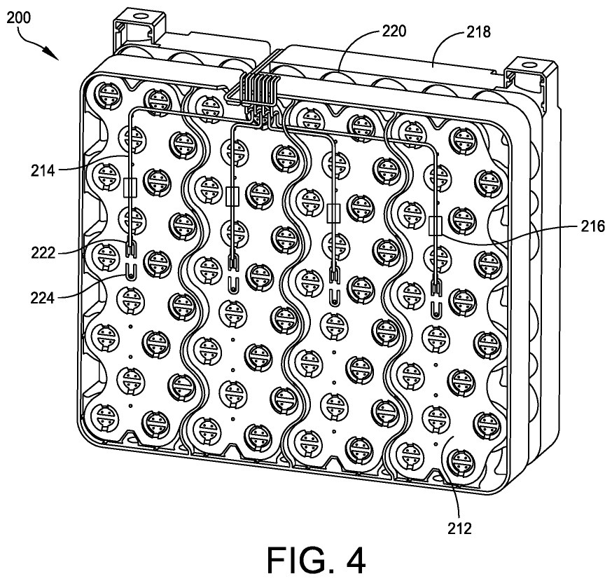

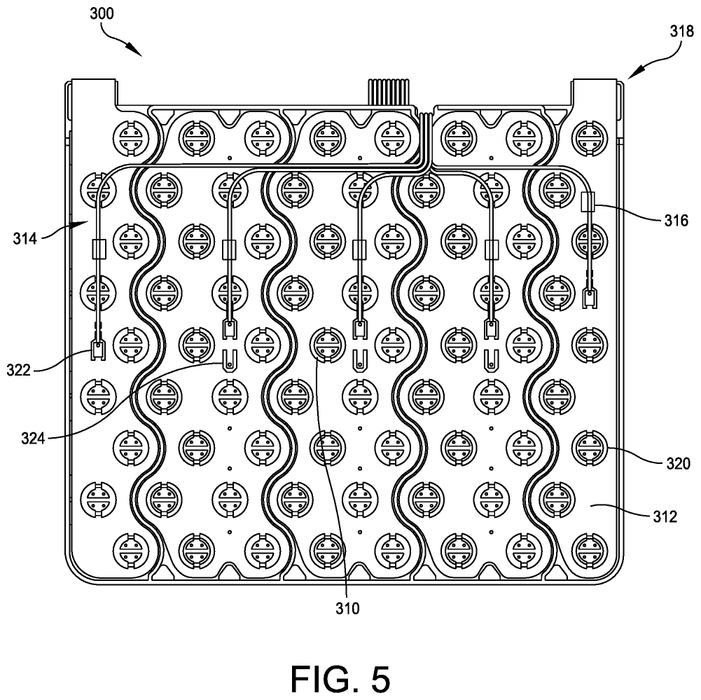

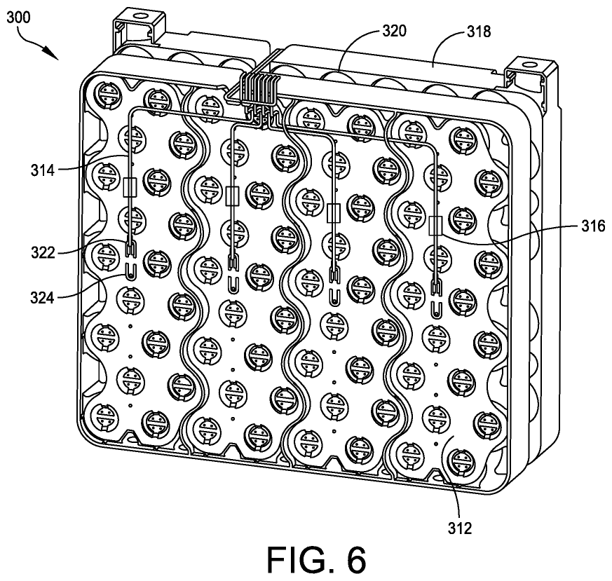

An example of use of the components inside the lithium battery pack 10 will now be described with reference to FIGS. 2 to 8.

Referring now to FIG. 2, there is shown a module 100 where a low module 101 and a high module 103 are connected in series in accordance with one embodiment. Although the low module 101 and the high module 103 connected in series is described, one of ordinary skill will appreciate, based on the present disclosure, that multiple modules, with various architectures, can be connected in alternative series and parallel configurations, according to embodiments of the present invention. In some embodiments of the present invention, the low module 101 and the high module 103 each have seventy-two (72) 26650 lithium iron phosphate cylindrical cells 120 configured in an 8S9P architecture that produces a 24V output and has about a 34 Ah current, with the “S” being the number of supercells connected in series and “P” being the number of cells connected in parallel. For example, each singular 26650 lithium iron phosphate cylindrical cell, meaning each cell has a diameter of about twenty-six (26) millimeters and a length of about sixty-five (65) millimeters, is a single cathode (positive) and anode (negative) separated by an electrolyte, which is a transport mechanism between the cathode and anode, that produces a 3.2V output and a 3.8 Ah current. Whereas, a supercell is defined as a collection of those singular lithium iron phosphate cylindrical cells 120 all connected in parallel.

With there being a plurality of 26650 lithium iron phosphate cylindrical cells 120, the design allows for simple changes in the way in which 26650 cylindrical cells 120 are stacked (orientation wise) in a module. Additionally, the cells 120 can be connected in various series and parallel combinations to alter the voltage and power in the same footprint with minimal changes to the design and manufacturing process. In an alternative embodiment, as long as the cells used are still 26650 cylindrical cells, different capacity cells can be used to alter the overall capacity of the module.

In a preferred embodiment, the module 100 is a 16S9P module where the low module 101 is connected to the high module 103 in series, producing about a 48V output (16 supercells multiplied by 3.2V output of each singular cell) with about a 34 Ah current (9 cells connected in parallel multiplied by 3.8 Ah). In the 16S9P module, for example, the low module 101 refers to the lithium iron phosphate cylindrical cells 120 one (1) through eight (8) and the high module 103 refers to the lithium iron phosphate cylindrical calls 120 nine (9) through sixteen (16), with lithium iron phosphate cylindrical cell sixteen (16) being the most positive or high cell of the battery and lithium iron phosphate cylindrical cell one (1) being the most negative or low cell of the battery.

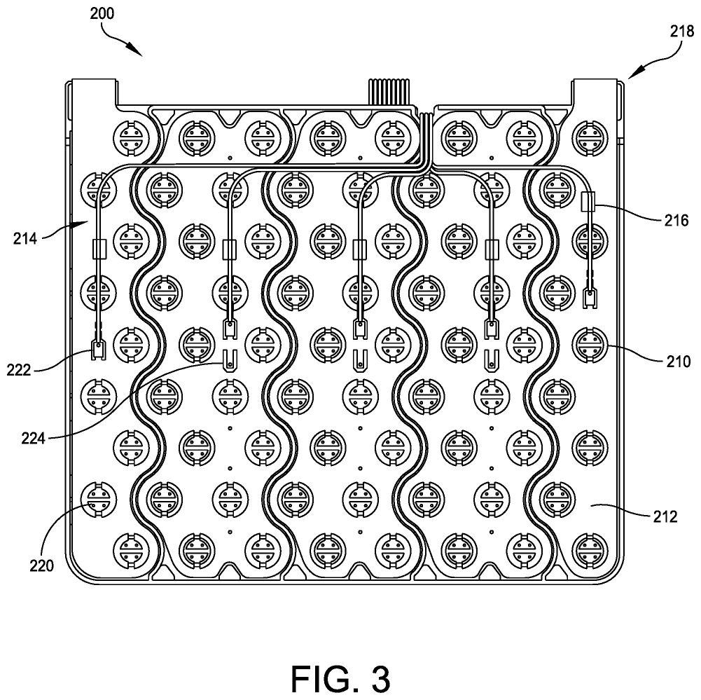

Referring now to FIGS. 3 to 6, there is shown front and rear views of a low module 200 and a high module 300 in accordance with various embodiments. In one aspect of the embodiment, the low module 200 and the high module 300 are two separate identical modules that are connected in series in the battery pack. The low module 200 is described. For the sake of brevity, the configuration and elements of the high module 300 that are similar to those corresponding to the low module 200 are not repeated.

In some embodiments of the present invention, the module 200 contains seventy-two (72) 26650 lithium iron phosphate cylindrical cells 220. The lithium iron phosphate cylindrical cells 220 are connected to one another by current collect plates 212 that are fully connected by a resistive welding process that forms strong, reliable welds intended to withstand high vibration applications. By limiting the number of mechanical connections with the module, the risk of connection issues due to vibration and shock is reduced. Although a resistive welding process is described, one of ordinary skill will appreciate, based on the present disclosure, that alternatively, the lithium iron phosphate cylindrical cells 220 can be interconnected to the current collector plates 212 by any suitable connection mechanism, such as, but not limited to, soldering, hard wiring, or connectors, according to embodiments of the present invention. Once the lithium iron phosphate cylindrical cells 220 are interconnected to the current collector plates 212, the lithium iron phosphate cylindrical cells 220 and the current collector plates 212 are enclosed in a flame retardant cell holder 218. In an embodiment, the flame retardant material of the cell 218 will be an acrylonitrile butadiene styrene (ABS) with a UL94-V-0 plastics flammability rating.

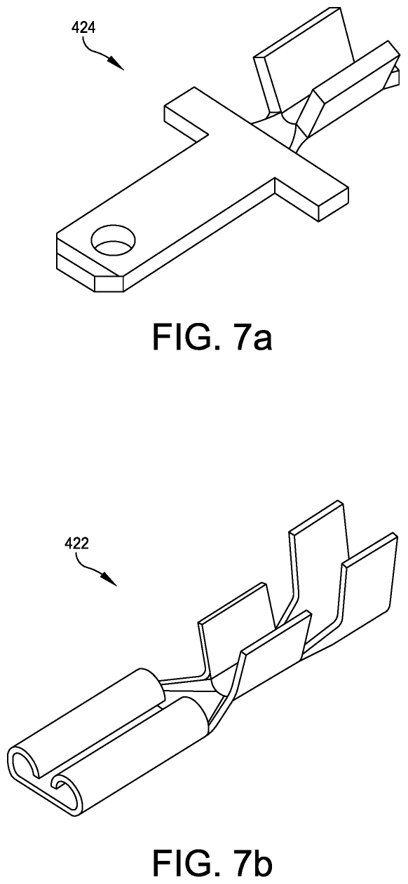

Referring now to FIGS. 7a and 7b, there is shown a custom stamped tab 424 and a quick disconnect tab 422 in accordance with various embodiments. In one aspect of the embodiment, each current collector plate (not pictured here) includes a tab 424 that is custom stamped in the current collector plate to allow for fast and reliable connections to the supercells. The tabs 424 are connected to the battery management system (not pictured here) by voltage sense wires (not pictured here) that have a quick disconnect tab 422 on the end to create an electrical contact/connection to the tabs 424. When the tabs 424 are connected to the quick disconnect tabs 422, the quick disconnect tabs 422 act as connection points/voltage sensors that are able to monitor the voltage of each of the supercells and allows the battery management system to balance the cells (not pictured here) to keep the modules at an even state of charge.

In one aspect of the embodiment, the quick disconnect tabs 422 are standard faston tabs. Although the standard faston tab is described, one of ordinary skill will appreciate, based on the present disclosure, that various alternatives, such as, but not limited to, a ring terminal, can be used, according to embodiments of the present invention. The benefit of using faston tabs for the quick disconnect tabs 422, for example, is that they take up minimal space and, when connected to the tabs 424, the connection does not require a bolted mechanical connection, which can increase the chance of the connection loosening due to vibration. The faston tab 422 easily slides onto the mating tab 424 and uses a special detent feature to prevent it from detaching inadvertently.

Referring back to FIGS. 3 to 6, the battery management system is connected to the module 200 by running voltage sense wires 214 with quick disconnect tabs 222 on the end to the custom stamped tabs 224 in the current collector plates 212. The number of voltage sense wires 214 depends on the number of current collector plates 212 in the module 200. For example, if there are five (5) current collector plates in the module, then there are five (5) voltage sense wires running from the battery management system to the custom stamped tabs in the current collector plates. On the other hand, the number of current collector plates 212 is a function of the design and the overall voltage of the pack. As shown, the 8S9P low module 200, when connected in series with the high module 300, has five (5) current collector plates 212, and thus five (5) voltage sense wires 214, on the front side of the module 200 and four (4) current collector plates 214, and thus four (4) voltage sense wires 214, on the rear side of the module 200. For instance, on a 48V product using a 3.2V lithium iron phosphate cylindrical cell, sixteen (16) supercells are needed to achieve the nominal 48V rating (16 multiplied by 3.2V). The 48V product will have nine (9) current collector plates in each module and eighteen (18) total in the pack. The nine (9) plates on each module 200, 300 each include three (3) unique plates: a negative 1S9P terminal, a positive 1S9P terminal, and seven (7) universal 2S9P plates, with three (3) universal 2S9P plates located on the front of the module and four (4) universal 2S9P plates located on the rear of the module. Although, nine (9) current collector plates 212 and nine (9) leads 214 are shown, any number of current collector plates 212 and voltage sense wires 214 is possible depending on the configuration of and the number of lithium iron phosphate cylindrical cells 220.

In one aspect of the embodiment, each voltage sense wire 214 has a piece of polyimide material 216 taped onto it to route and maintain the position of the voltage sense wires 214 to prevent the voltage sense wires 214 from being pinched during the assembly process. Additionally, polyimide material 216 has good insulation properties and is difficult to tear. Although a polyimide material 216 is described, one of ordinary skill will appreciate, based on the present disclosure, that any suitable alternative adhesive, such as a dab of silicon RVT, can be used, according to embodiments of the present invention.

In yet another aspect of the embodiment, temperature sensors 210, which are connected to the battery management system, are strategically mounted on the module 200 to measure and monitor the cells' 220 surface for temperature excursions. In the event that the lithium iron phosphate cylindrical cells 220 are outside of their recommended operating temperature range, the battery management system acts and prevents an unsafe condition by temporarily shutting down until the proper parameters are restored or, in an extreme case, a hard shut down occurs that will prevent future use of the battery. The recommended operating temperatures are as follows: 0° C. to 45° C. (32° F. to 113° F.) during charge; −20° C. to 60° C. (−4° F. to 140° F.) during discharge; and −40° C. to 60° C. (−40° F. to 140° F.) in storage. In an embodiment, three temperature sensors 210 are mounted on the low module 200 and one temperature sensor is mounted on the high module 300. Although four temperature sensors are shown, any number is possible to provide the battery management system with a sufficient understanding of the temperatures throughout the modules.

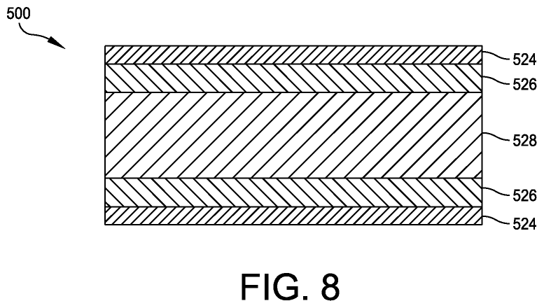

Referring now to FIG. 8, there is shown a five-layer clad material 500 in accordance with one embodiment. Although the five-layer clad material 500 is described, one of ordinary skill will appreciate, based on the present disclosure, that any suitable structure can be used for the current collector plates (not pictured here), such as, but not limited to, a generally planar electrical connection system, according to embodiments of the present invention. For example, a generally planar electrical connection system can be defined as a printed circuit board, a wiring board, or any other suitable configuration with conductive traces. In an embodiment, the lithium iron phosphate cylindrical cells (not pictured here) are interconnected with the five-layer clad material 500 used for the current collector plates. The five-layer clad material 500 is copper 528 at the core, for current carrying, sandwiched between layers of stainless steel 526, for welding, with a corrosion resistant layer of nickel 524 on the top and bottom surfaces.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What is claimed is:

1. A lithium iron phosphate module comprising:
a plurality of lithium iron phosphate cylindrical cells;
at least two current collector plates, wherein the plurality of lithium iron phosphate cylindrical cells are interconnected to the current collector plates; and
at least two cell holders enclosing the lithium iron phosphate cylindrical cells and the current collector plates.

2. The lithium iron phosphate module of claim 1, wherein the plurality of lithium iron phosphate cylindrical cells are configurable to make different series and parallel configurations.

3. The lithium iron phosphate module of claim 2, wherein the plurality of lithium iron phosphate cylindrical cells are in an 8S9P configuration with a 24V output and a 34 Ah current.

4. The lithium iron phosphate module of claim 1, wherein the plurality of lithium iron phosphate cylindrical cells each have a diameter of about twenty-six millimeters and a length of about sixty-five millimeters.

5. The lithium iron phosphate module of claim 1, wherein the plurality of lithium iron phosphate cylindrical cells are interconnected to the current collector plates by a resistive welding process.

6. The lithium iron phosphate module of claim 5, wherein the current collector plates are a five-layer clad material, wherein the clad material comprises:
two layers of corrosion resistant nickel on the surface;
two layers of stainless steel between the two layers of nickel; and
a copper layer at the core.

7. The lithium iron phosphate module of claim 1, wherein a front side of the lithium iron phosphate module comprises five current collector plates.

8. The lithium iron phosphate module of claim 1, wherein a rear side of the lithium iron phosphate module comprises four current collector plates.

9. The lithium iron phosphate module of claim 1, further comprising at least two custom stamped tabs, wherein one tab is custom stamped on each respective current collector plate.

10. The lithium iron phosphate module of claim 9, further comprising a battery management system, wherein the battery management system is connected to each custom stamped tab by running a voltage sense wire from the battery management system to the custom stamped tab.

11. The lithium iron phosphate module of claim 10, wherein a quick disconnect tab is used at the end of the voltage sense wire to mate the voltage sense wire to the custom stamped tab in the current collector plate.

12. The lithium iron phosphate module of claim 11, wherein the battery management system monitors and balances the voltage of the lithium iron phosphate cylindrical cells through the quick disconnect tab connection.

13. The lithium iron phosphate module of claim 10, wherein the voltage sense wires are taped to the current connector plates by a polyimide material.

14. The lithium iron phosphate module of claim 1, further comprising a plurality of temperature sensors.

15. The lithium iron phosphate module of claim 1, wherein a first lithium iron phosphate module is connected to a second lithium iron phosphate module in series.

16. The lithium iron phosphate module of claim 1, wherein the first lithium iron phosphate module is a low module and the second lithium iron phosphate module is a high module.

17. The lithium iron phosphate module of claim 15, wherein the first lithium iron phosphate module and the second lithium iron phosphate module each comprise seventy-two lithium iron phosphate cylindrical cells in an 8S9P configuration with a 48V output and a 34 Ah current.

18. The lithium iron phosphate module of claim 17, wherein each of the one hundred forty-four lithium iron phosphate cylindrical cells has a diameter of about twenty-six millimeters and a length of about sixty-five millimeters.

19. The lithium iron phosphate module of claim 17, wherein the plurality of lithium iron phosphate cylindrical cells are interconnected to the current collector plates by a resistive welding process.

20. The lithium iron phosphate module of claim 19, wherein the current collector plates are a five-layer clad material, wherein the clad material comprises:
two layers of corrosion resistant nickel on the surface;
two layers of stainless steel between the two layers of nickel; and
a copper layer at the core.

21. The lithium iron phosphate module of claim 16, wherein a front side of the low module comprises five current connector plates and a rear side of the low module comprises four current connect plates.

22. The lithium iron phosphate module of claim 16, wherein a front side of the high module comprises five current connector plates and a rear side of the high module comprises four current connect plates.

23. The lithium iron phosphate module of claim 15, further comprising at least four custom stamped tabs, wherein one tab is custom stamped on each respective current collector plate.

24. The lithium iron phosphate module of claim 23, further comprising a battery management system, wherein the battery management system is connected to each custom stamped tab by running a voltage sense wire from the battery management system to the custom stamped tab.

25. The lithium iron phosphate module of claim 24, wherein a quick disconnect tab is used at the end of the voltage sense wire to mate to the voltage sense wire to the custom stamped tab in the current collector plate.

26. The lithium iron phosphate module of claim 25, wherein the battery management system monitors and balances the voltage of the lithium iron phosphate cylindrical cells through the quick disconnect tab connection.

27. The lithium iron phosphate module of claim 23, wherein the voltage sense wires are taped to the current connector plates by a polyimide material.

28. The lithium iron phosphate module of claim 16, further comprising temperature sensors, wherein the low module comprises three temperature sensors and the high module comprises one temperate sensor.

29. The lithium iron phosphate module of claim 15, wherein the first lithium iron phosphate module and the second lithium iron phosphate module is packed into a GC2 battery group size.

30. A battery, comprising:
a housing, comprising:
two electrical connection terminals;
a first module, comprising:
a first set of lithium iron phosphate cylindrical cells;
at least two current collector plates, wherein the first set of lithium iron phosphate cylindrical cells are interconnected to the current collector plates; and
a first pair of cell holders enclosing the first set of lithium iron phosphate cylindrical cells and the current collector plates;
a second module, comprising:
a second set of lithium iron phosphate cylindrical cells;
at least two current collector plates, wherein the second set of lithium iron phosphate cylindrical cells are interconnected to the current collector plates; and
a second pair of cell holders enclosing the second set of lithium iron phosphate cylindrical cells and the current collector plates; and
a battery management system, wherein the battery management system is connected to the first module and the second module to manage the first set of lithium iron phosphate cylindrical cells and the second set of lithium iron phosphate cylindrical cells.

31. The battery of claim 28, further comprising a cover with at least two lifting brackets.

32. The battery of claim 30, further comprising at least one temperature sensor connected to the battery management system, wherein the temperature sensor is mounted on the first module or the second module at a predetermined location.

33. The battery of claim 32, wherein the temperature sensor reads the temperature of the lithium iron phosphate cylindrical cell.

34. The battery of claim 33, wherein the battery management system shuts down if the temperature reading of the temperature sensor is outside 0° C. to 45° C. when charging, −20° C. to 60° C. when discharging, and −40° C. to 60° C. when being stored.

35. The battery of claim 30, wherein the first set of lithium iron phosphate cylindrical cells are interconnected to the current collector plates of the first module by a resistive welding process and the second set of lithium iron phosphate cylindrical cells are interconnected to the current collector plates of the second module by a resistive welding process.

36. The battery of claim 30, further comprising at least four custom stamped tabs, wherein one tab is custom stamped on each respective current collector plate of the first module and one tab is custom stamped on each respective current collector plate of the second module.

37. The battery of claim 36, wherein the battery management system is connected to each custom stamped tab by running a voltage sense wire from the battery management system to the custom stamped tab.

38. The battery of claim 37, wherein a quick disconnect tab is used at the end of the voltage sense wire to mate the voltage sense wire to the custom stamped tab in the current collector plate.

39. The battery of claim 38, wherein the battery management system monitors and balances the voltage of the first set of lithium iron phosphate cylindrical cells and the second set of lithium iron phosphate cylindrical cells through the quick disconnect tab connections.

40. The battery of claim 30, wherein the current collector plates are a five-layer clad material, wherein the clad material comprises:
two layers of corrosion resistant nickel on the surface;
two layers of stainless steel between the two layers of nickel; and
a copper layer at the core.
